(19) United States
(12) Patent Application Publication
(10) Pub. No.: US 2008/0241632 A1
(43) Pub. Date: Oct. 2, 2008

(54) Use of Hydrophilic Treatment in a Water Vapor Transfer Device

(75) Inventors: Ivan D. Chapman, Victor, NY (US); Reena L. Datta, Rochester Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/694,633

(22) Filed: Mar. 30, 2007

(51) Int. Cl. H01M 8/04; B01J 7/00

(52) U.S. Cl. 429/34; 137/561 R

(57) ABSTRACT

A WVT unit that humidifies a cathode inlet airflow to a fuel cell stack in a fuel cell system. In one embodiment, the WVT unit includes a series of membranes separated by plates defining flow channels at both sides of the membrane. The humidifying gas, typically a cathode outlet gas from the fuel cell stack, flows down the flow channels on one side of each membrane and the cathode inlet air flows down the flow channels on an opposite side of each membrane. According to the invention, the plates have a hydrophilic film so that more water vapor in the humidifying flow channels is exposed to the membrane, and therefore more water is transferred to the cathode airflow.

### BACKGROUND OF THE INVENTION

1. Field of the Invention

This invention relates generally to a water vapor transfer (WVT) unit for humidifying an inlet flow to a fuel cell stack in a fuel cell system and, more particularly, to a WVT unit for humidifying a cathode inlet airflow to a fuel cell stack in a fuel cell system, where flow channel plates within the WVT unit have a hydrophilic film so that membranes within the WVT unit are exposed to maximum possible water or highest possible water vapor pressure so as to improve the amount of water/water vapor that is transferred to the cathode inlet air stream.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons on the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer proton conducting membrane as the electrolyte, such as a perfluorosulfonic acid membrane. The anode and cathode typically include finely divided catalytic particles, usually platinum (Pt), supported on carbon particles and mixed with a proton conducting ionomer that is typically the same ionomer as used in the membrane. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates may also include flow channels through which a cooling fluid flows.

As is well understood in the art, fuel cell membranes typically operate with a certain relative humidity (RH) so that the ionic resistance across the membrane is low enough to effectively conduct protons. The relative humidity of the cathode outlet gas from the fuel cell stack is typically controlled to control the relative humidity of the membranes by controlling several stack operating parameters, such as stack reactant pressure, temperature, cathode stoichiometry and the relative humidity of the inlet gas stream into the stack.

As mentioned above, water is generated on the cathode side as a by-product of the stack operation. Therefore, the cathode exhaust gas from the stack will include water vapor and may include liquid water. It is known in the art to use a water vapor transfer (WVT) unit to capture some of the water or water vapor in the cathode exhaust gas, and use the water to humidify the cathode input airflow. Typically, the WVT unit includes flow channels defined by plates and a water transfer membrane positioned therebetween. Water in the cathode exhaust gas flowing down the flow channels at one side (wet side) of the membrane is absorbed by the membrane and transferred to the cathode air stream flowing down the flow channels at the other side (dry side) of the membrane.

It has been proposed in the art to deposit a hydrophilic coating on bipolar plates for a fuel cell to improve channel water transport. The hydrophilic coating causes water in the channels to form a thin film that has less of a tendency to alter the flow distribution along the array of channels connected to the common inlet and outlet headers. If the plate material is sufficiently wettable, water transport through the diffusion media will contact the channel walls and then, by capillary force, be transported into the bottom corners of the channel along its length.

### SUMMARY OF THE INVENTION

In accordance with the teachings of the present invention, a WVT unit is disclosed that humidifies a cathode inlet airflow to a fuel cell stack in a fuel cell system. In one embodiment, the WVT unit includes a series of membranes separated by plates defining flow channels at both sides of the membrane. The humidifying gas, typically a cathode outlet gas from the fuel cell stack, flows down the flow channels on one side of each membrane and the cathode inlet air flows down the flow channels on an opposite side of each membrane. According to the invention, the plates have a hydrophilic film so that the increased wetted area will help increase the local water vapor pressure in the humidifying flow channels, and therefore more water is transferred to the cathode airflow.

Additional features of the present invention will become apparent from the following description and appended claims, taken in conjunction with the accompanying drawings.

### BRIEF DESCRIPTION OF THE DRAWINGS

FIG. 1 is a schematic plan view of a fuel cell system including a WVT unit having plates with a hydrophilic film, according to an embodiment of the present invention; and

FIG. 2 is a cross-sectional view of a portion of the WVT unit shown in FIG. 1 including a series of membranes and a series of plates defining flow channels, where the plates include the hydrophilic film, according to an embodiment of the present invention.

### DETAILED DESCRIPTION OF THE EMBODIMENTS

The following discussion of the embodiments of the invention directed to a WVT unit for a fuel cell system having flow channels plates with a hydrophilic film is merely exemplary in nature, and is in no way intended to limit the invention or its applications or uses.

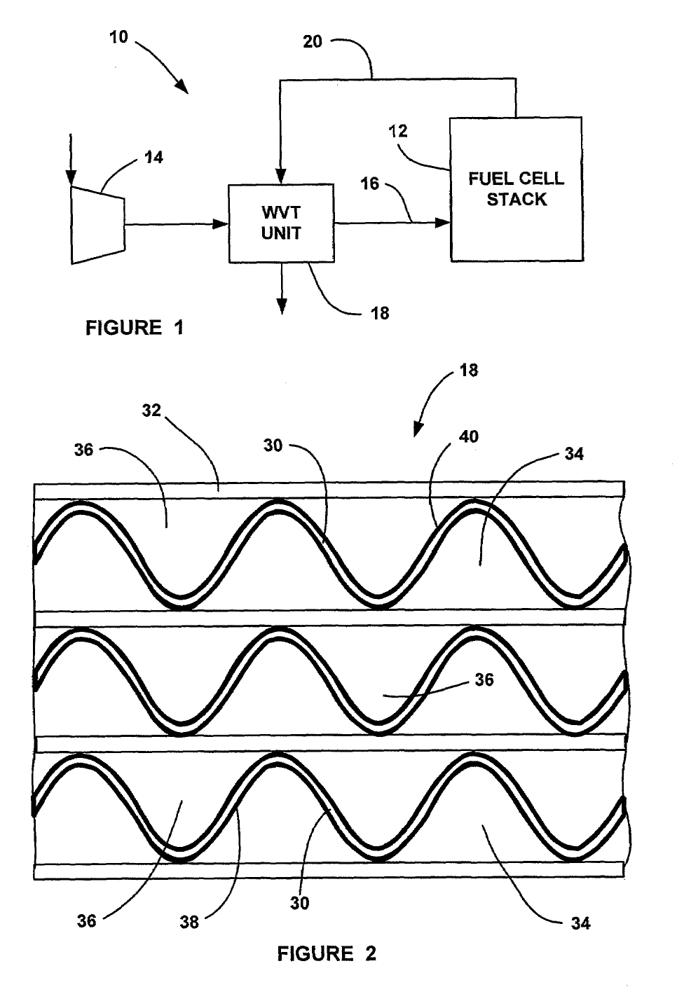

FIG. 1 is a schematic block diagram of a fuel cell system 10 including a fuel cell stack 12. A compressor 14 provides a flow of air to the cathode side of the stack 12 on cathode input line 16. The flow of air from the compressor 18 is sent through a WVT unit 18 to be humidified. A cathode exhaust gas is output from the stack 12 on cathode output line 20. The cathode exhaust gas includes a considerable amount of water and water vapor as a result of the by-product of the electrochemical process in the stack 12. As is well understood in the art, the cathode exhaust gas can be sent to the WVT unit 18 to provide the humidification for the cathode inlet airflow on the line 14.

FIG. 2 is a cross-sectional view of a portion of the WVT unit 18. The WVT unit 18 includes a series of plates 30 that define flow channels, and a series of saturable membranes 32 positioned between each pair of adjacent plates 30. The flow channels include flow channels 34 on one side of each membrane 32 and flow channels 36 on an opposite side of each membrane 32. The cathode inlet air flows down the flow channels 34 and the cathode exhaust gas flows down the flow channels 36. Water and water vapor in the cathode exhaust gas saturates the membranes 32 and the dry cathode air from the compressor 14 picks up humidification from the membranes 32 to provide the desired wetness for the membranes in the stack 12.

The membranes 32 can be made of any suitable saturable material, and have any suitable thickness for the purposes described herein. Further, the plates 30 can be made of any suitable plate material to provide the flow channels 34 and 36. In one non-limiting embodiment, the plates 30 are stainless steel plates that are stamped into the shape shown so that flow channels 34 and 36 are defined on each side of the plates 30. In other embodiments, the plates can be other materials that do not contaminate the MEAs or catalyst, such as aluminum or plastic. If the plates are aluminum, then they may need to be coated to prevent MEA contamination.

According to the invention, the plates 30 are coated with a hydrophilic material to form a hydrophilic film 38 on one side of each plate 30 and a hydrophilic film 40 on an opposite side of each plate 30. As discussed above, it is known in the art to treat the bipolar plates, such as stainless steel bipolar plates, within the fuel cell stack 12 with a hydrophilic material to cause water in the flow channels defined by each plate to form a film, and not bead up. The film 40 would have the same effect for the water and water vapor in the cathode exhaust gas by increasing the surface area of water exposed to the gas streams and the membranes 32. Particularly, the efficiency of the WVT unit 18 is limited by how much water vapor is exposed to the membranes 32, and therefore how much water vapor can be transferred to the cathode air stream. The film 40 will cause a water film to form across the plates 30 as opposed to localized wetting on a non-hydrophilic plate, thereby increasing the water vapor transfer efficiency of the WVT unit 18.

In one embodiment, the hydrophilic films are a metal oxide. Suitable metal oxides for the hydrophilic coatings include, but are not limited to, silicon dioxide (SiO₂), silicon nitride (Si₃N₄), hafnium dioxide (HfO₂), zirconium dioxide (ZrO₂), aluminum oxide (Al₂O₃), tin oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂) and mixtures thereof.

In another embodiment, the hydrophilic films 38 and 40 are carbides. Suitable carbides include, but are not limited to, chromium carbide, titanium carbide, tantalum carbide, niobium carbide and zirconium carbide.

In another embodiment, the hydrophilic films 38 and 40 can be formed by a chromic acid etch that roughens the surface of the plates to increase their hydrophilicity.

The hydrophilic material can be deposited on the plates 30 by any suitable technique including, but not limited to, physical vapor deposition (PVD) processes, chemical vapor deposition (CVD) processes, thermal spraying processes and sol-gel. Suitable examples of physical vapor deposition processes include electron beam evaporation, magnetron sputtering and pulsed plasma processes. Suitable chemical vapor deposition processes include plasma enhanced CVD and atomic layer deposition processes.

In the embodiment shown in FIG. 2, the hydrophilic films 38 and 40 are provided on both sides of the plates 30. However, in an alternate embodiment, the process for depositing the hydrophilic films 38 and 40 can be such that the film is only deposited on the side of the plate 30 that defines the flow channels 36 for the cathode exhaust gas.

In an alternate embodiment, the plates 30 themselves are made of a hydrophilic material, and thus, the hydrophilic films 38 and 40 may not be needed.

In an alternate embodiment, the surface of the plates 30 are made hydrophilic by modifying the surface material by a suitable process, such as a chromic etch, and thus, the hydrophilic films 38 and 40 may not be needed.

Also, the anode inlet stream can be humidified using the WVT device of the invention.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A water vapor transfer unit for humidifying an inlet stream being sent to a fuel cell stack, said unit comprising:
a plurality of spaced apart membranes; and
a plurality of plates positioned between the membranes, said plates being configured to define flow channels where the flow channels facing one side of each membrane provide water vapor to the membranes and the flow channels facing an opposite side of each membrane collect water vapor from the membranes, and wherein the side of the plate that provides the water vapor includes a hydrophilic coating that causes the water vapor to form a film on the plate and transfer water vapor to the membrane more efficiently.

2. The unit according to claim 1 wherein the plurality of plates are stamped metal plates.

3. The unit according to claim 1 wherein the plates are stainless steel.

4. The unit according to claim 1 wherein each plate includes a hydrophilic coating on both sides of the plate.

5. The unit according to claim 1 wherein the hydrophilic coating is a metal oxide.

6. The unit according to claim 5 wherein the metal oxide is selected from the group consisting of silicon dioxide (SiO₂), silicon nitride (Si₃N₄), hafnium dioxide (HfO₂), zirconium dioxide (ZrO₂), aluminum oxide (Al₂O₃), tin oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂) and mixtures thereof.

7. The unit according to claim 1 wherein the hydrophilic coating is a carbide.

8. The unit according to claim 7 wherein the carbide is selected from the group consisting of chromium carbide, titanium carbide, tantalum carbide, niobium carbide and zirconium carbide.

9. The unit according to claim 1 wherein the hydrophilic coating is a chromic acid etch that roughens the surface of the plates.

10. The unit according to claim 1 wherein the hydrophilic coating is deposited on the plates by a process selected from the group consisting of physical vapor deposition (PVD) processes, chemical vapor deposition (CVD) processes, thermal spraying processes and sol-gel.

11. The unit according to claim 1 wherein the water vapor is provided by a cathode exhaust gas from the stack.

12. The unit according to claim 1 wherein the water vapor transfer unit is part of a fuel cell system on a vehicle.

13. A fuel cell system comprising;
a fuel cell stack, said stack receiving a cathode inlet airflow stream and exhausting a cathode exhaust gas; and
a water vapor transfer unit for humidifying the cathode airflow stream being sent to the fuel cell stack, said water vapor transfer unit including a plurality of spaced apart membranes and a plurality of plates positioned between the membranes, said plates being configured to define flow channels where the flow channels facing one side of each membrane receive the cathode exhaust gas to provide water vapor to the membranes and the flow channels facing an opposite side of each membrane receive the cathode airflow stream that collects water vapor from the membranes, wherein the flow channels on the side of the plates that receive the cathode exhaust gas include a hydrophilic coating that causes the water vapor to form a film on the plate and transfer water vapor to the membrane more efficiently.

14. The system according to claim 13 wherein the plurality of plates are stamped metal plates.

15. The system according to claim 14 wherein the plates are stainless steel.

16. The system according to claim 13 wherein each plate includes a hydrophilic coating on both side of the plate.

17. The system according to claim 13 wherein the hydrophilic coating is a metal oxide.

18. The system according to claim 17 wherein the metal oxide is selected from the group consisting of silicon dioxide (SiO₂), silicon nitride (Si₃N₄), hafnium dioxide (HfO₂), zirconium dioxide (ZrO₂), aluminum oxide (Al₂O₃), tin oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂) and mixtures thereof.

19. The system according to claim 13 wherein the hydrophilic coating is a carbide.

20. The system according to claim 19 wherein the carbide is selected from the group consisting of chromium carbide, titanium carbide, tantalum carbide, niobium carbide and zirconium carbide.

21. The system according to claim 13 wherein the hydrophilic coating is a chromic acid etch that roughens the surface of the plates.

22. The system according to claim 13 wherein the hydrophilic coating is deposited on the plates by a process selected from the group consisting of physical vapor deposition (PVD) processes, chemical vapor deposition (CVD) processes, thermal spraying processes and sol-gel processes.

23. A water vapor transfer unit for humidifying an inlet stream being sent to a fuel cell stack, said unit comprising:
a plurality of spaced apart membranes; and
a plurality of plates positioned between the membranes, said plates being configured to define flow channels where the flow channels facing one side of each membrane provide water vapor to the membranes and the flow channels facing an opposite side of each membrane collect water vapor from the membranes, and wherein the plate is hydrophilic to cause the water vapor to form a film on the plate and transfer water vapor to the membrane more efficiently.
